(19) United States
(12) Patent Application Publication
(10) Pub. No.: US 2006/0244721 A1
(43) Pub. Date: Nov. 2, 2006

(54) Flat panel display with function button

(75) Inventors: Te-Hsu Wang, Miao-Li (TW); Ming-Chuan Li, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/414,928

(22) Filed: May 1, 2006

(30) Foreign Application Priority Data
Apr. 29, 2005 (TW) 94206891

(51) Int. Cl. G09G 5/00

(52) U.S. Cl. 345/156

(57) ABSTRACT

A flat panel display (1) includes a display panel (10), a circuit board (20), a housing (30), and a button circuit (22). The circuit board is electrically connected to the display panel. The housing includes a front housing part (32), and a rear housing part (34) with an integral function button (342), wherein the display panel and the circuit board are secured by the front housing part and the rear housing part. The button circuit is arranged on the circuit board at the position with respect to the function button.

### FIELD OF THE INVENTION

The present invention relates to flat panel displays, and in particular to a flat panel display having a function button on the back.

### BACKGROUND

Generally, a flat panel display has several function buttons on the front thereof, for controlling characteristics of images shown on a screen of the flat panel display such as luminance and contrast ratio.

FIG. 7 is an exploded, isometric view of a typical flat panel display. The flat panel display 100 comprises a front housing part 101, a rear housing part (not shown), a display panel 102, a circuit board (not shown) electrically connected to the display panel 102, and a button module 103.

The display panel 102 is secured by the front housing part 101 and the rear housing part. A plurality of button through holes 1011 and an indication light 1012 are provided at a lower section of the front housing part 101. The indication light 1012 is for indicating a status of operation of the flat panel display 100 to a user. The button module 103 is sandwiched between the front housing part 101 and the display panel 102. The button module 103 comprises several function buttons 1031, a button circuit board 1032 with a button circuit, and a securing element 1033. The button circuit board 1032 and the function buttons 1031 are secured on the front housing part 101 by the securing element 1033. The function buttons 1031 are arranged in positions corresponding to the button through holes 1011, and penetrate through the button through holes 1011 once the flat display panel 100 is assembled. The button module 103 is electrically connected to the circuit board of the display 102 via a connecting wire (not shown). The user can control the display characteristics of the flat panel display 100 by operating the function buttons 1031.

Because the button module 103 is designed as a separate unit, the connecting wire for connecting the circuit board of the display panel 102 with the button module 103 is necessary. The connecting wire adds to the complexity of the assembly and raises the cost of the flat panel display 100.

Accordingly, what is needed is a relatively simple and inexpensive flat panel display.

### SUMMARY

A flat panel display includes a display panel, a circuit board, a housing, and a button circuit. The circuit board is electrically connected to the display panel. The housing includes a front housing part, and a rear housing part with an integral function button, wherein the display panel and the circuit board are secured by the front housing part and the rear housing part. The button circuit is provided on the circuit board at a position corresponding to the function button.

The functional button of the flat panel display above-mentioned is cantilevered, and the function button is arranged at a right section of the rear housing part, or at a left section of the rear housing part. The flat panel display further includes an indication light and a guiding symbol. The indication light is provided on the front housing part at a position corresponding to the function button, and the guiding symbol is formed on the front housing part at the position opposite to the function button. The flat panel display further includes a metal shield covering the circuit board.

Compared to conventional flat panel displays, the function buttons are integrally formed on the rear housing part, and a connecting wire between a button circuit and a main circuit board is eliminated. The process of assembly of the flat panel display is simplified, and costs are reduced.

A detailed description of various embodiments is provided below with reference to the accompanying drawings.

### BRIEF DESCRIPTION OF THE DRAWINGS

Embodiments of the invention can be more fully understood by reading the subsequent detailed description and examples with reference to the accompanying drawings, wherein:

FIG. 1 is an exploded, isometric front view of a flat panel display in accordance with a first embodiment of the present invention;

FIG. 2 is an exploded, isometric back view of the flat panel display shown in FIG. 1;

FIG. 3 is an assembled view of the flat panel display shown in FIG. 1;

FIG. 4 is an assembled view of the flat panel display shown in FIG. 2;

FIG. 5 is a back plan view of the flat panel display shown in FIG. 4;

FIG. 6 is a back plan view of a flat panel display in accordance with a second embodiment of the present invention; and

FIG. 7 is an exploded, isometric view of a flat panel display of the prior art.

### DETAILED DESCRIPTION OF EMBODIMENTS

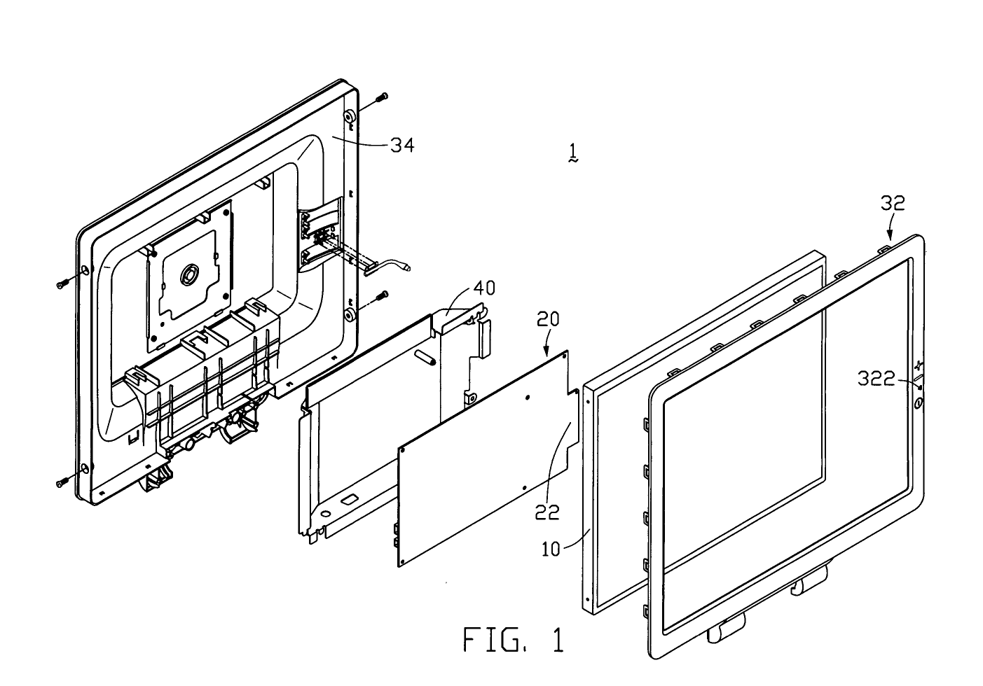

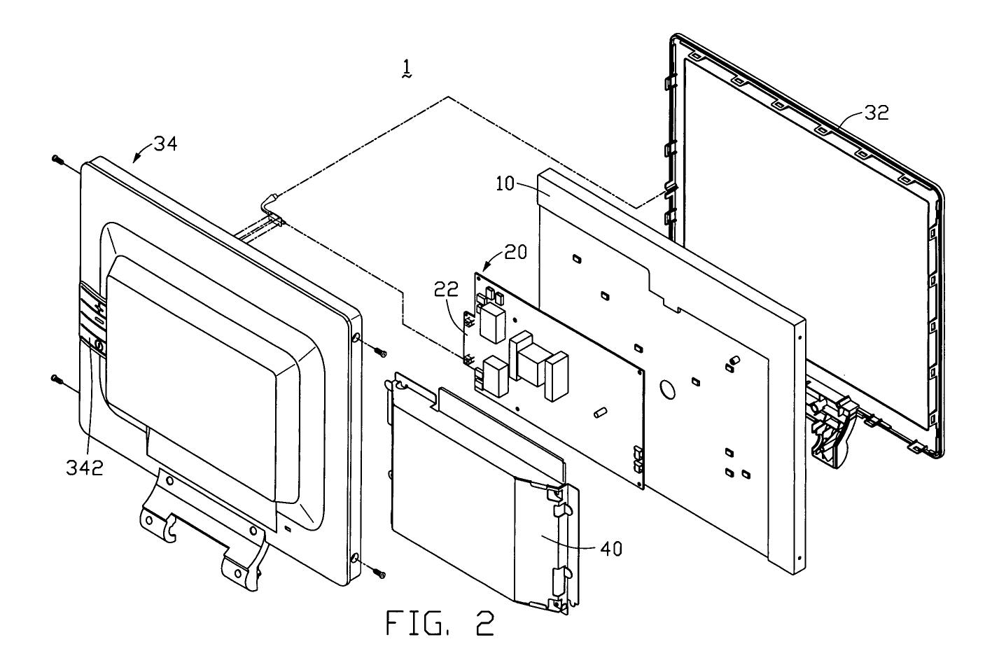

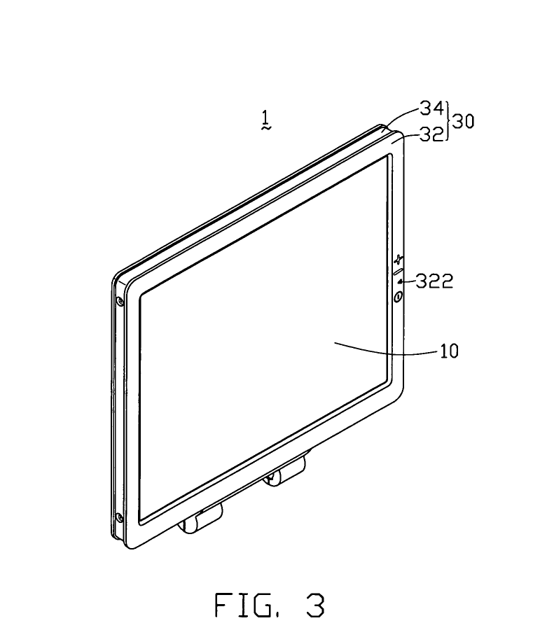

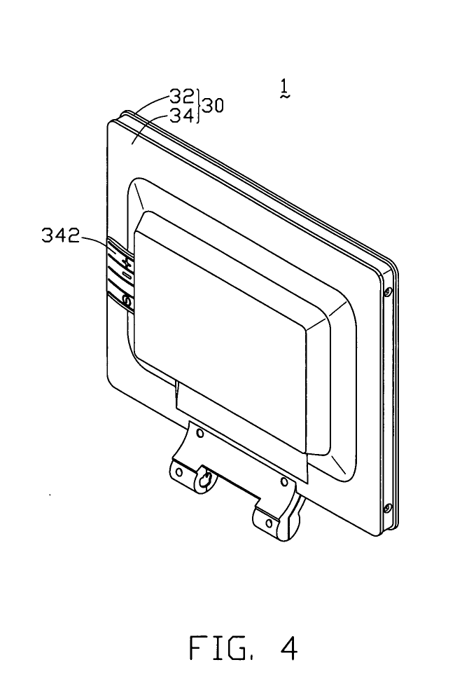

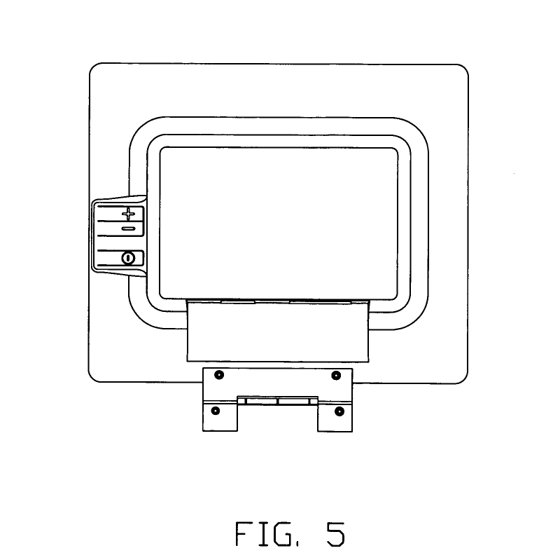

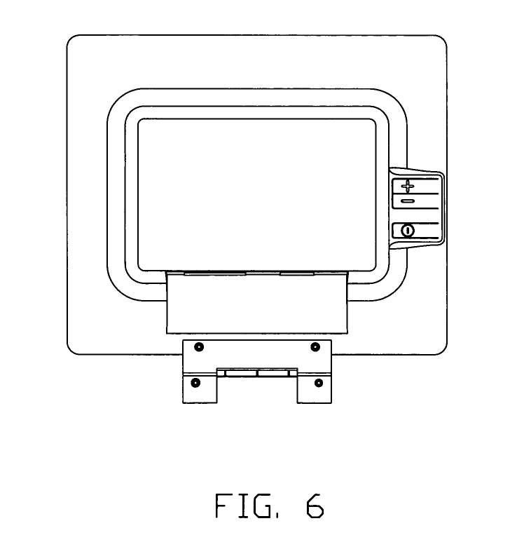

Referring to FIG. 1 through FIG. 6, a flat panel display 1 comprises a display panel 10, a circuit board 20, a housing 30, and a metal shield 40. The circuit board 20 is electrically connected to the display panel 10. The housing 30 comprises a front housing part 32 and a rear housing part 34. The display panel 10 and the circuit board 20 are secured by the front housing part 32 and the rear housing part 34. The metal shield 40 is for securing and covering the circuit board 20 and for shielding electromagnetic interference (EMI).

Three cantilevered function buttons 342 are integrally formed at a right side section of the rear housing part 34. A plurality of slits is defined in the rear housing part 34 around the function buttons 342, thereby providing the function buttons 342 with elasticity. A button circuit 22 is formed on the circuit board 20 at a position corresponding to the function buttons 342.

Three indication lights 322 and three guiding symbols are formed at a right side section of the front housing part 32, at positions respectively corresponding to the function buttons 342. The indication lights 322 are used for indicating respective statuses of the flat panel display 1 to a user, and the guiding symbols are used for guiding the user to press a corresponding desired one of the function buttons 342 on the rear housing part 34.

Because the function buttons 342 of the flat panel display 1 are integrated with the rear housing part 34, the flat panel display 1 is relatively simple in construction and correspondingly inexpensive. In particular, unlike in comparable prior art, the flat panel display 1 does not need a connecting wire for connecting the button circuit 22 to the circuit board 20. The process of assembly of the flat panel display 1 is simplified, and costs are reduced.

Assembly of the flat panel display 1 is as follows. Firstly, the display panel 10 is electrically connected to the circuit board 20. Secondly, the metal shield 40 is arranged on the circuit board 20 as a shelter. Finally, the display panel 10, circuit board 20, and the metal shield 40 are secured by the front housing part 32 and the rear housing part 34.

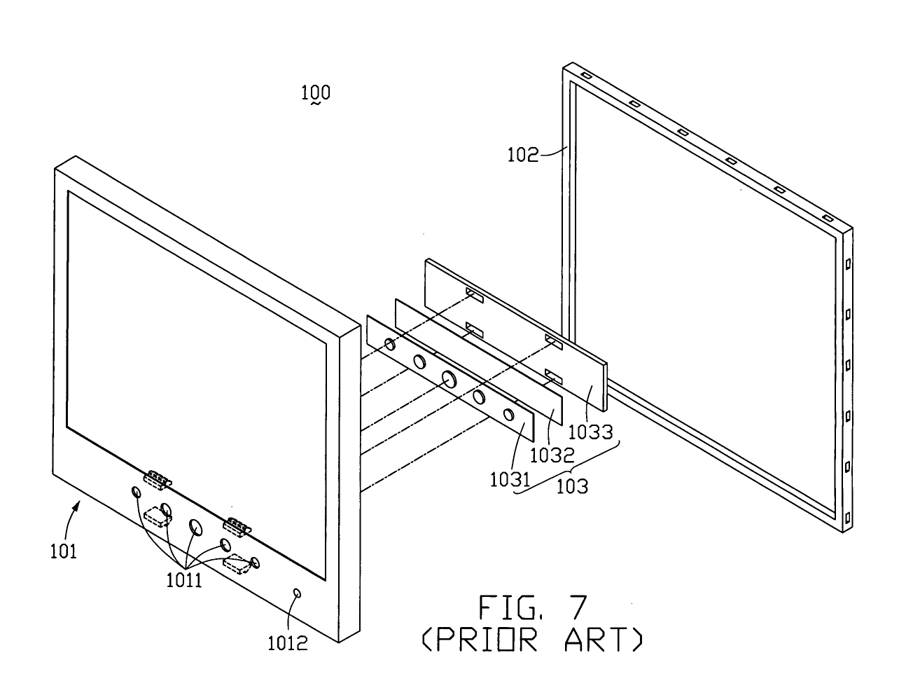

The flat panel display 1 may have alternative embodiments to those described above. For example, the function buttons 342 can be formed at a left side section of the rear housing part 34 (as shown in FIG. 7), or at an upper or a lower section of the rear housing part 34. In these embodiments, the button circuit 22 on the circuit board 20 is positioned according to the positions of the function buttons 342. In other examples, the function buttons 342 may be positioned at two or more of the right side, left side, upper and lower sections of the rear housing part 34. In these embodiments, there are two or more corresponding button circuits 22 on the circuit board 20, which are positioned according to the positions of the function buttons 342. In still other examples, there may be only one or two function buttons 342; or there may be four or more function buttons 342.

While the invention has been described by way of example and in terms of the preferred embodiments, it is to be understood that the invention is not limited thereto. To the contrary, the above description is intended to also cover various modifications and similar arrangements as would be apparent to those skilled in the art. Therefore, the scope of the appended claims should be accorded the broadest interpretation so as to encompass all such modifications and similar arrangements.

What is claimed is:

1. A flat panel display, comprising:
a display panel;
a circuit board electrically connected to the display panel;
a housing comprising a front housing part, and a rear housing part with an integral function button, wherein the display panel and the circuit board are secured by the front housing part and the rear housing part; and
a button circuit provided on the circuit board at a position corresponding to the function button.

2. The flat panel display as claimed in claim 1, wherein the function button is cantilevered.

3. The flat panel display as claimed in claim 1, wherein the function button is arranged at a right section of the rear housing part.

4. The flat panel display as claimed in claim 1, wherein the function button is arranged at a left section of the rear housing part.

5. The flat panel display as claimed in claim 1, further comprising an indication light provided on the front housing part at a position corresponding to the function button.

6. The flat panel display as claimed in claim 1, further comprising a guiding symbol provided on the front housing part at a position corresponding to the function button.

7. The flat panel display as claimed in claim 1, further comprising a metal shield covering the circuit board.

8. A flat panel display, comprising:
a display panel;
a circuit board electrically connected to the display panel;
a housing comprising a front housing part, and a rear housing part cooperating with each other to secure the display panel and the circuit board therebetween; and
a function button formed on the rear housing and operable from a rear side so as to narrow a frame of the front housing for obtaining a screen as large as possible.
